(19) United States
(12) Patent Application Publication
(10) Pub. No.: US 2016/0008701 A1
(43) Pub. Date: Jan. 14, 2016

(54) CARD GAME AND METHOD FOR PLAYING THE SAME

(71) Applicants: Charles D Dulin, Phoenix, AZ (US); David M Dulin, Phoenix, AZ (US); Kendra L Inman, Phoenix, AZ (US); Beau Robinson, Goodyear, AZ (US)

(72) Inventors: Charles D Dulin, Phoenix, AZ (US); David M Dulin, Phoenix, AZ (US); Kendra L Inman, Phoenix, AZ (US); Beau Robinson, Goodyear, AZ (US)

(21) Appl. No.: 14/860,796

(22) Filed: Sep. 22, 2015

Related U.S. Application Data
(62) Division of application No. 14/265,677, filed on Apr. 30, 2014.

(51) Int. Cl. A63F 1/00; G09B 19/22

(52) U.S. Cl. CPC A63F 1/00; G09B 19/22

(57) ABSTRACT

The present invention is a deck of cards and method of use in a card game, wherein the object of the game is for one of the plurality of players to collect all cards, comprising a plurality of playing cards for displaying visual indicia and a plurality of predetermined visual indicia on said plurality of playing cards wherein at least one of the plurality of visual indicia comprises numbers or objects with a unique hierarchal ranking, at least one of the plurality of visual indicia comprises a command for comparison of discarded cards, and at least one of the plurality of visual indicia comprises a command for the plurality of players to touch the discarded cards.

### RELATED APPLICATIONS

This application is a divisional of U.S. patent application Ser. No. 14/265,677 filed Apr. 30, 2014. The entire contents of the above application are hereby incorporated by reference as though fully set forth herein.

### FIELD

The present invention relates to the field of card games. More specifically, the present invention relates to a slap, smack, touch, push, tap and speaking method of game play.

### BACKGROUND

Playing cards are used as a form of entertainment. In addition to providing entertainment, playing cards have been used as an educational tool. Many playing card games in the prior art teach children the alphabet, numbers, colors and even matching of elements with identical elements on the cards. While there are many fun “matching” type card games, there exists a need for a card game that can be played for entertainment while concurrently teaching and reinforcing comparison of numbers, as well as enhancing reflexes.

### BRIEF SUMMARY OF THE INVENTION

It is the object of the present invention to provide a deck of cards for use in a method of playing a card game, wherein the object of the game is for one of the plurality of players to collect all cards dealt to the other plurality of players. One embodiment of the present invention is a deck of cards for use in a card game comprising a plurality of playing cards for displaying visual indicia, the deck of cards adapted to be dealt to each of the plurality of players; and a plurality of predetermined visual indicia on said plurality of playing cards wherein at least one of the plurality of visual indicia comprises numbers or objects with a unique hierarchal ranking, at least one of the plurality of visual indicia comprises a command for comparison of discarded cards, and at least one of the plurality of visual indicia comprises a command for the plurality of players to touch the discarded cards. A further embodiment of the present invention comprises using said deck of cards; distributing equally among a plurality of players all cards with the visual indicia facing down; and discarding one of the distributed cards by each of the plurality of players in a predetermined manner, the discarded cards facing up in order to reveal its visual indicia.

Details of one or more embodiments of the invention are set forth further in the detailed description below.

### BRIEF DESCRIPTION OF THE DRAWINGS

FIG. 1. FIG. 1 is an illustration of one embodiment of the present invention using numbers with a hierarchal ranking displayed on the cards.

FIG. 2. FIG. 2 is an illustration of one embodiment of the present invention using a “challenge” card as the visual indicia for comparing cards.

FIG. 3. FIG. 3 is an illustration of one embodiment of the present invention using a “Smack It!” card as the visual indicia for touching cards.

FIG. 4. FIG. 4 is an illustration of the discard pile of one embodiment of the present invention using numbers with a hierarchal ranking displayed on the cards.

FIG. 5. FIG. 5 is an overview illustration of one embodiment of the method for playing a card game of the present invention.

### DETAILED DESCRIPTION

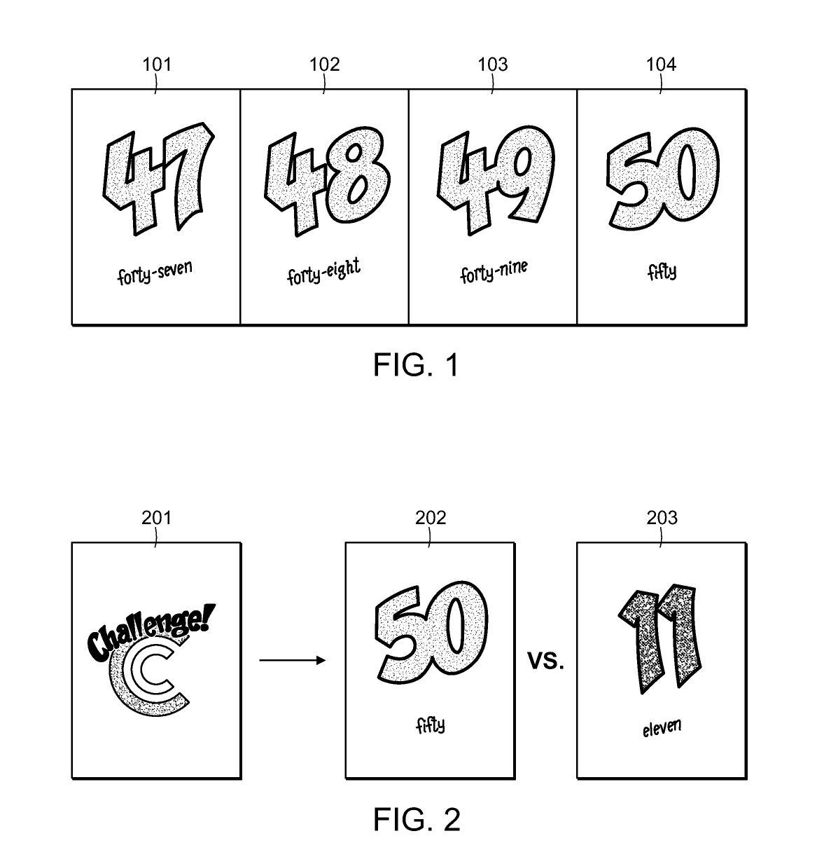

According to the preferred embodiment of the present invention, a deck of cards for use in a card game, wherein the object of the game is for one of the players to collect all the cards is adapted to be dealt to each of a plurality of players. The plurality of playing cards displays a plurality of predetermined visual indicia. As shown in FIG. 1, some of the cards' visual indicia display numbers with a unique hierarchal ranking For example, card 101 shows the word “forty-seven” and number “47”, card 102 shows the word “forty-eight” and the number “48”, card 103 shows the word “forty-nine” and the number “49”, card 104 shows the word “fifty” and the number “50.” The cards are capable of being compared and placed in order by its numerical hierarchal ranking However, the cards may also display other unique object capable a hierarchal ranking, such as letters.

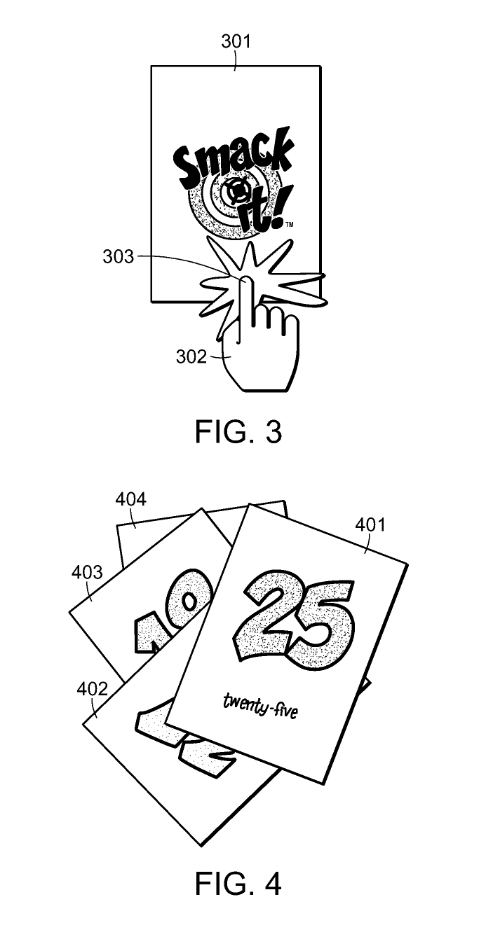

In the preferred embodiment of the present invention, some of the cards' visual indicia display commands. One of the commands indicates a command to compare discarded cards. For example, as shown in FIG. 2, the command card 201 says “challenge.” Another of the commands indicates a command for the plurality of players to touch the discarded cards. For example, as shown in FIG. 3, the command card 301 says “Smack it!”

In one embodiment of the present invention, about 50 of the plurality of cards display numbers or objects with a unique hierarchal ranking; about 4 of the plurality of cards display a command for comparison of discarded cards; and about 2 of the plurality of cards display a command for the plurality of players to touch the discarded cards.

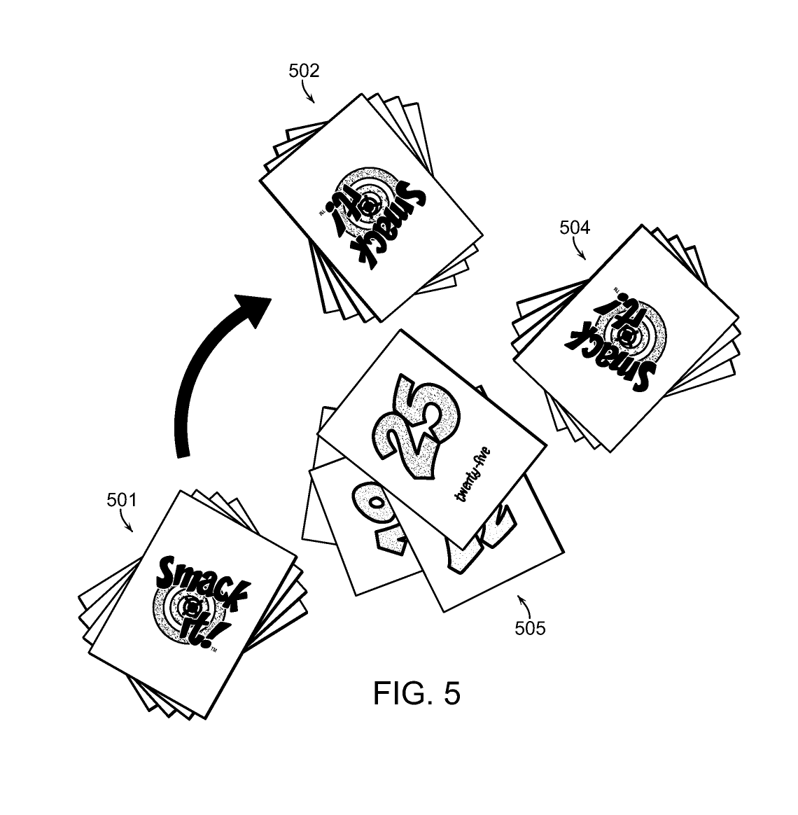

The method for playing the card game using the above described deck of cards comprises providing the deck of cards described above; distributing the cards equally among all of the plurality of players with the visual indicia facing down; and discarding one of the distributed cards by each of the plurality of players in a predetermined manner with the discarded cards facing up in a pile between the players to reveal the discarded cards' visual indicia. For example, as shown in FIG. 5, three players are distributed to the players face down into piles represented as 501, 502 and 504. In the preferred embodiment, the player on the dealer's left starts the game by quickly flipping the top card of their pile away from them to create a central pile of face-up cards represented as 505 within easy reach of all players. Faster play is encouraged. Players must never look at their cards or crowd the central pile. As shown in FIG. 4, play continues clockwise with each player, in turn, quickly flipping a single top card 404, 403, 402 and 401 with a visual indicia of a number or object with a unique hierarchal ranking until a command card is placed on top of the central pile.

When a card is played wherein the visual indicia comprises a command for comparison, all players flip one card, in turn, and place it on the central pile 505. The player with the highest hierarchal ranked card wins the pile and ends the challenge round. If, during a challenge round, a player places another card wherein the visual indicia comprises a command for comparison on the pile, the challenge round immediately starts over. For example, as shown in FIG. 2, when card 201 with a visual indicia of “Challenge!” which comprised a command for comparison, the first player flips card 202 to display a card with a visual indicia of the number “50 and the second player flips card 203 to display a card with a visual indicia of the number “11.” In this example, the first player has the highest hierarchal ranked card as 50 is greater than 11 and therefore the first player collects the pile of discarded cards below.

Anytime a command card with visual indicia comprising a command for the plurality of players to touch the discarded cards is placed on top of the pile (discarded), the first player to touch this card collects the pile of discarded cards below. In the event of a tie, the player's hand that is closest to the center of the visual indicia on the command card wins. For example, as shown in FIG. 3, when card 301 with a visual indicia of “Smack it!” which comprised a command for the plurality of players to touch the discarded cards is played, the player's hand 302 that touches the card 301 using body part 303 (in this case the finger tip) collects the pile of discarded cards below. If two players touch the card 301 at the same time, the player with their body part 303 closest to the center of the “Smack it!” visual indicia would win the round.

As shown in FIG. 5, when a player wins the central pile 505, those cards are added face-down to their own pile (501, 502 or 504 as the case may be) and they restart game play. A player touching any card but the command card with the visual indicia for touching the discarded cards or caught cheating must forfeit one card and place it face-up at the bottom of the central pile.

Players with no cards have lost the game. However, they can still harass remaining players by touching the command card with the visual indicia for touching the discarded cards, and, if successfully won, remove those cards from play. The player to their left restarts the game. If a player with no cards “false touches” they are out of the game.

The act of “touching” the cards includes but is not limited to slapping, smacking, pushing, or tapping the cards.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for playing a card game, wherein the object of the game is for one of a plurality of players to obtain all the cards possessed by the others of the plurality, the method comprising:
i) providing a deck of cards having a plurality of playing cards for displaying visual indicia, the deck of cards adapted to be dealt to each of the plurality of players wherein at least one of the plurality of visual indicia comprises numbers or objects with a unique hierarchal ranking, at least one of the plurality of visual indicia comprises a command for comparison of discarded cards, and at least one of the plurality of visual indicia comprises a command for the plurality of players to touch the discarded cards wherein about 50 of the plurality of playing cards' visual indicia comprise numbers or objects with a unique hierarchal ranking; wherein about 4 of the plurality of playing cards' visual indicia comprise a command for comparison of discarded cards; and wherein about 2 of the plurality of playing cards' visual indicia comprise a command for the plurality of players to touch the discarded cards;
ii) distributing equally among a plurality of players all cards with the visual indicia facing down;
iii) discarding one of the distributed cards by each of the plurality of players in a predetermined manner, the discarded cards facing up in order to reveal its visual indicia wherein the discarded cards are further adapted to be collected by one of the plurality of the players when the visual indicia is not a number or object with a unique hierarchal ranking; and wherein the discarded cards are further adapted to be collected by one of the plurality of players when the visual indicia comprises a command for comparison of discarded cards;
iv) comparing said numbers or objects by hierarchal ranking on the next discarded card by each of the plurality of players when the card with the visual indicia comprises a command for comparison of discarded cards is discarded wherein one of the plurality of players collects all previously discarded cards when their next discarded card is higher in hierarchal ranking value compared to the cards discarded by the other plurality of players wherein one of the plurality of players collects all previously discarded cards when their next discarded card is higher in hierarchal ranking value compared to the cards discarded by the other plurality of players; and
v) touching the discarded cards by each of the plurality of players when the card with the visual indicia comprises a command for the plurality of players to touch the discarded cards is discarded wherein one of the plurality of players that first touches the card with the command for the plurality of players to touch the discarded cards collects all previously discarded cards.
